(19) United States
(12) Patent Application Publication
(10) Pub. No.: US 2026/0196914 A1
(43) Pub. Date: Jul. 9, 2026

(54) Power Conversion Circuit with Limit Power Source and Control Method Thereof

(71) Applicant: Richtek Technology Corporation, Zhubei City (TW)

(72) Inventors: Syuan-Zong Lan, Changhua (TW); Shin-Li Lin, Taichung (TW); Yan-Chen Wu, Nantou (TW)

(21) Appl. No.: 19/405,381

(22) Filed: Dec. 1, 2025

Related U.S. Application Data
(60) Provisional application No. 63/743,382, filed on Jan. 9, 2025.

(30) Foreign Application Priority Data
Nov. 21, 2025 (TW) 114145660

(51) Int. Cl. H02M 1/00; H02M 1/08; H02M 1/32

(52) U.S. Cl. CPC H02M 1/0009; H02M 1/0083; H02M 1/08; H02M 1/327

(57) ABSTRACT

A power conversion circuit includes: a path switch for controlling a conduction path of a supply voltage to a bus voltage; a first current sensing circuit for generating a current sensing voltage according to a current supplied to a load; a second current sensing circuit including the path switch or a conductive trace segment, configured to generate a determination voltage according to the current; and a power control circuit for performing a limit power source (LPS) control procedure according to the current sensing and the determination voltage. The LPS control procedure includes: a determination step for determining whether the current sensing voltage is lower than a sensing threshold and whether an absolute value of the determination voltage is higher than an absolute value of a determination threshold; and an LPS operation for limiting an output power related to the current. When determination result is affirmative, the LPS operation is performed.

### CROSS REFERENCE

The present invention claims priority to provisional application 63/743,382 filed on January 9, 2025, and TW 114145660 filed on November 21, 2025.

### BACKGROUND OF THE INVENTION

### Field of Invention

The present invention relates to a power conversion circuit, and more particularly to a power conversion circuit with a limit power source (LPS) function. The present invention also relates to a control method for controlling the aforementioned power conversion circuit.

### Description of Related Art

In power applications such as Universal Serial Bus Power Delivery (USB PD), in order to comply with the Limit Power Source (LPS) regulations, the system must be capable of preventing excessive output power that may cause overload even when a single component fails (e.g., a failure of a current sensing resistor). Prior art techniques typically rely on precision power calculation circuits in conjunction with firmware algorithms, or utilize communication via the CC pin along with current detection to determine whether to enter the LPS mode. Although these approaches can achieve protection, they commonly suffer from issues such as complex circuitry, increased component costs, heavy firmware loading, and susceptibility to misjudgment during startup or transition periods. Additional multi-stage logic and timing mechanisms are often required to suppress false alarms (debounce).

### SUMMARY OF THE INVENTION

From one perspective, the present invention provides a power conversion circuit configured to generate a supply voltage according to an input voltage, comprising: a path control switch coupled between the supply voltage and a bus voltage, configured to control a conduction path of the supply voltage to the bus voltage, wherein the bus voltage is configured to provide a current to a load; a first current sensing circuit including a sensing resistor serially coupled to a current path of the current, configured to generate a current sensing voltage according to the current; a second current sensing circuit including the path control switch or a conductive trace segment, wherein the path control switch or the conductive trace segment is serially coupled to the current path, configured to generate a determination voltage according to the current; and a power control circuit configured to control the path control switch and perform a limit power source (LPS) control procedure according to the current sensing voltage and the determination voltage; wherein the LPS control procedure includes: a first determination step of determining whether the current sensing voltage is lower than a sensing threshold and whether an absolute value of the determination voltage is higher than an absolute value of a determination threshold; and an LPS operation configured to limit an output power related to the current; wherein when a result of the first determination step is affirmative, the LPS operation is performed.

In one embodiment, the power control circuit is implemented as an integrated circuit; wherein a first end and a second end of the first current sensing circuit are coupled to a first pair of pins of the power control circuit, the first pair of pins corresponding to a sensing pin and a ground pin of the power control circuit; wherein a first end and a second end of the second current sensing circuit are coupled to a second pair of pins of the power control circuit; wherein the power control circuit is configured in one of the following: a first configuration, in which when the second current sensing circuit generates the determination voltage by the path control switch, the second pair of pins correspond to a power pin and a bus pin of the power control circuit, a first terminal of the path control switch is coupled to the power pin, a second terminal of the path control switch is coupled to the bus pin, a control terminal of the path control switch is coupled to a control pin of the power control circuit, and the determination voltage corresponds to a conduction voltage of the path control switch when turned on; or a second configuration, in which when the second current sensing circuit generates the determination voltage by the conductive trace segment, the second pair of pins correspond to the ground pin of the power control circuit and a first pin, a first end of the conductive trace segment is coupled to the ground pin, a second end of the conductive trace segment is coupled to the first pin, and the determination voltage corresponds to a cross-voltage between the first end and the second end of the conductive trace segment.

In one embodiment, the power control circuit includes: a first amplification circuit coupled to the first pair of pins and configured to amplify the current sensing voltage to generate a first amplified signal; an analog-to-digital conversion circuit configured to convert the first amplified signal to generate a first digital amplified signal in digital domain, and a determination circuit configured to perform the LPS control procedure according to the first digital amplified signal and the determination voltage.

In one embodiment, when the power control circuit is in the first configuration, the analog-to-digital conversion circuit is further configured to convert the conduction voltage to generate a second digital amplified signal in digital domain, and the determination circuit is further configured to perform the LPS control procedure according to the first digital amplified signal and the second digital amplified signal; or wherein when the power control circuit is in the first configuration, the power control circuit further includes a comparator configured to compare the conduction voltage with the determination threshold to generate a comparison signal, and the determination circuit is further configured to perform the LPS control procedure according to the first digital amplified signal and the comparison signal.

In one embodiment, the LPS control procedure further includes a first delay operation of waiting for a first delay time, and when a result of the first determination step is affirmative, the first delay operation is further performed and the LPS operation is subsequently performed.

In one embodiment, the LPS control procedure further includes a second determination step of determining whether the path control switch is turned on and a second delay operation of waiting for a second delay time, and when a result of the second determination step is affirmative, the second delay operation is subsequently performed and the first determination step is performed.

In one embodiment, the LPS operation includes turning off the path control switch or increasing an on-resistance of the path control switch.

In one embodiment, a current sensing threshold corresponding to the sensing threshold is lower than an absolute value of a current determination threshold corresponding to the determination threshold.

In one embodiment, when the power control circuit is in the second configuration, the power control circuit further includes a second amplification circuit configured to, through the second pair of pins, amplify the cross-voltage of the conductive trace segment to generate a second amplified signal; wherein the analog-to-digital conversion circuit is further configured to convert the second amplified signal to generate a third digital amplified signal in digital domain, and the determination circuit is further configured to perform the LPS control procedure according to the first digital amplified signal and the third digital amplified signal.

In one embodiment, a second end of the conductive trace segment is further coupled to the first pin via a temperature sensing resistor, and the power control circuit further includes a current source circuit configured to provide a bias current; wherein during a first period, the second amplification circuit receives the cross-voltage of the conductive trace segment through the first pin and the determination circuit is configured to perform the LPS control procedure according to the first digital amplified signal and the third digital amplified signal; wherein during a second period, the current source circuit is configured to provide the bias current to the temperature sensing resistor through the first pin so as to generate a cross-voltage across the temperature sensing resistor; wherein during the second period, the analog-to-digital conversion circuit is further configured to convert the cross-voltage of the temperature sensing resistor to generate a digital temperature sensing signal in digital domain; and wherein during the second period, the determination circuit is further configured to determine whether a temperature of the temperature sensing resistor is higher than an over-temperature protection threshold according to the digital temperature sensing signal.

From another perspective, the present invention provides a control method for controlling a power conversion circuit configured to generate a supply voltage according to an input voltage, comprising: controlling, by a path control switch, a conduction path of the supply voltage to a bus voltage, wherein the bus voltage is configured to provide a current to a load; generating a current sensing voltage according to the current by a first current sensing circuit including a sensing resistor serially coupled to a current path of the current; generating a determination voltage according to the current by a second current sensing circuit including the path control switch or a conductive trace segment serially coupled to the current path; and performing an LPS control procedure according to the current sensing voltage and the determination voltage; wherein the LPS control procedure includes: a first determination step of determining whether the current sensing voltage is lower than a sensing threshold and whether an absolute value of the determination voltage is higher than an absolute value of a determination threshold; and an LPS operation configured to limit an output power related to the current; wherein when a result of the first determination step is affirmative, the LPS operation is performed.

The power conversion circuit of the present invention performs dual determinations based on both a current sensing voltage and a determination voltage to perform a Limit Power Source (LPS) control procedure, thereby preventing continuous current increase and potential load damage caused by malfunction of the sensing resistor. When the current sensing voltage is lower than a sensing threshold and an absolute value of the determination voltage is higher than an absolute value of a determination threshold, the circuit performs the LPS operation to limit the output power related to the output current, thereby preventing abnormal current rise and protecting the load from damage. The control scheme can generate the determination voltage from either a conduction voltage of a path control switch or a cross-voltage of a conductive trace segment, and can further integrate delayed determination and temperature sensing control to achieve precise and reliable LPS protection.

The objectives, technical details, features, and effects of the present invention will be better understood with regard to the detailed description of the embodiments below, with reference to the attached drawings.

### BRIEF DESCRIPTION OF THE DRAWINGS

FIG. 1A and FIG. 1B respectively illustrate block diagrams of power conversion circuits in two embodiments of the present invention.

FIG. 2A illustrates a flowchart of an LPS (Limit Power Source) control procedure of the power conversion circuit in one embodiment of the present invention.

FIG. 2B illustrates a flowchart of an LPS control procedure of the power conversion circuit in another embodiment of the present invention.

FIG. 3A illustrates a schematic diagram of a power conversion circuit in one embodiment of the present invention.

FIG. 3B illustrates a schematic diagram of a power conversion circuit in one embodiment of the present invention.

FIG. 4A illustrates a schematic diagram of a power control circuit of the power conversion circuit in one embodiment of the present invention.

FIG. 4B illustrates a schematic diagram of a power control circuit of the power conversion circuit in one embodiment of the present invention.

FIG. 5 illustrates a waveform diagram of the power conversion circuit shown in FIG. 3A in one embodiment of the present invention.

FIG. 6A illustrates a schematic diagram of a power conversion circuit in one embodiment of the present invention.

FIG. 6B illustrates a schematic diagram of a power conversion circuit in one embodiment of the present invention.

FIG. 7 illustrates a schematic diagram of a power control circuit of the power conversion circuit in one embodiment of the present invention.

FIG. 8 illustrates a waveform diagram of the power conversion circuit shown in FIG. 6A in one embodiment of the present invention.

FIG. 9A illustrates a schematic diagram of a power conversion circuit in one embodiment of the present invention.

FIG. 9B illustrates a schematic diagram of a power conversion circuit in one embodiment of the present invention.

FIGS. 10A and 10B respectively illustrate schematic diagrams of a power control circuit of the power conversion circuit operating in different periods in one embodiment of the present invention.

FIG. 11A illustrates a waveform diagram of the power conversion circuit shown in FIG. 9A in one embodiment of the present invention.

FIG. 11B illustrates a waveform diagram of the power conversion circuit shown in FIG. 9A in another embodiment of the present invention.

FIG. 12 illustrates a flowchart of an LPS control procedure of the power conversion circuit in one embodiment of the present invention.

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

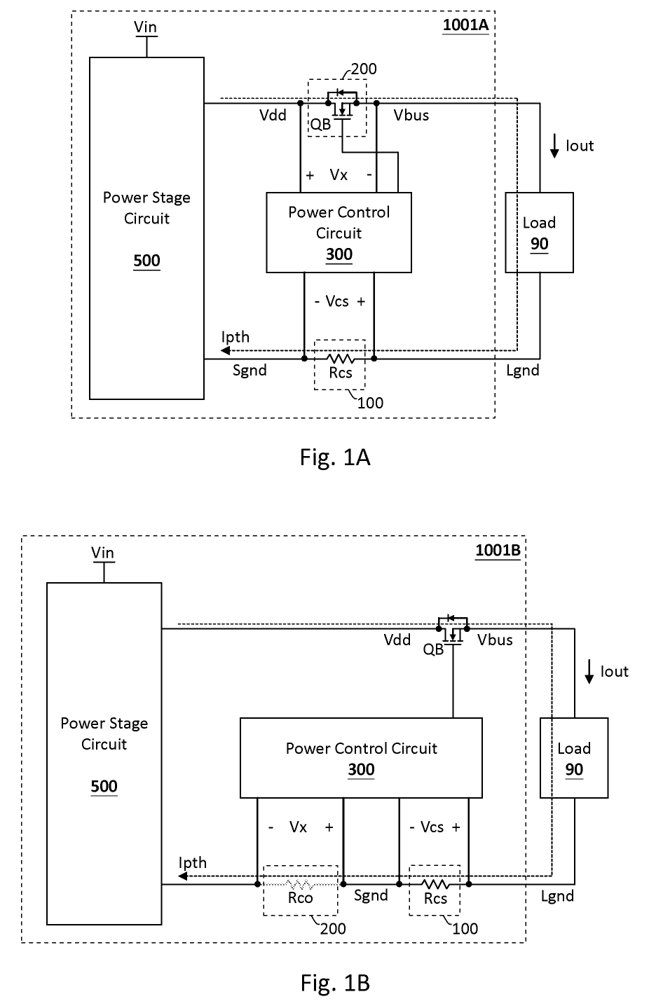

FIGS. 1A and 1B respectively illustrate block diagrams of power conversion circuits in two embodiments of the present invention. As shown in FIG. 1A, in one embodiment, a power conversion circuit 1001A includes a path control switch QB, a first current sensing circuit 100, a second current sensing circuit 200, a power control circuit 300, and a power stage circuit 500. In one embodiment, the power conversion circuit 1001A is configured to generate a supply voltage Vdd according to an input voltage Vin. Specifically, the power conversion circuit 1001A converts the input voltage Vin to the supply voltage Vdd via the power stage circuit 500. In one embodiment, the power stage circuit 500 is, for example, a switching converter.

In one embodiment, the path control switch QB is coupled between the supply voltage Vdd and a bus voltage Vbus, and is configured to control a conduction path from Vdd to Vbus. The bus voltage Vbus is configured to provide an output current Iout to a load 90. The first current sensing circuit 100 includes a sensing resistor Rcs serially coupled to the current path Ipth of the current Iout, and is configured to generate a current sensing voltage Vcs according to the current Iout. Specifically, one terminal of the sensing resistor Rcs is coupled to both the load 90 and the power control circuit 300 at a ground potential Lgnd, and the other terminal of the sensing resistor Rcs is coupled to the power control circuit 300 at another ground potential Sgnd. In one embodiment, the power control circuit 300 is configured to control the path control switch QB and perform an LPS control procedure according to the current sensing voltage Vcs and a determination voltage Vx.

As shown in FIG. 1B, in one embodiment, a power conversion circuit 1001B is also configured to generate the supply voltage Vdd according to the input voltage Vin. In the power conversion circuit 1001B shown in FIG. 1B, the configurations and operations of the path control switch QB, the first current sensing circuit 100, the power control circuit 300, and the power stage circuit 500 are the same as those in FIG. 1A (refer to the preceding description). The difference between the power conversion circuits 1001A and 1001B lies in the configuration and operation of the second current sensing circuit 200, which will be described in detail later.

In one embodiment, as shown in FIG. 1A, the second current sensing circuit 200 includes the path control switch QB serially coupled to the current path Ipth. In another embodiment, as shown in FIG. 1B, the second current sensing circuit 200 includes a conductive trace segment serially coupled to the current path Ipth (as shown by the gray line in FIG. 1B), which may be a section of copper trace on a printed circuit board. In this embodiment, the conductive trace segment has a non-zero trace resistance Rco. In one embodiment, the second current sensing circuits 200 of FIGS. 1A and 1B are configured to generate the determination voltage Vx according to the current Iout.

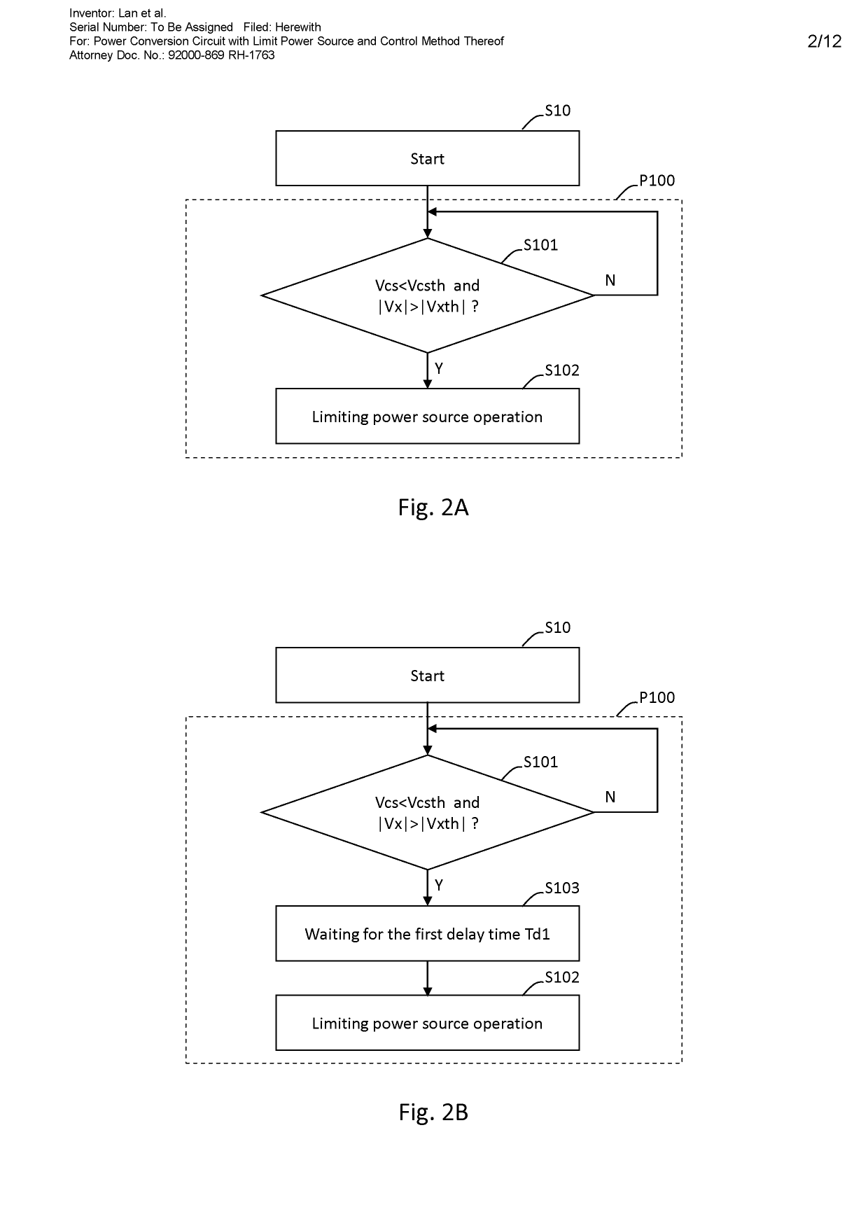

FIG. 2A illustrates a flowchart of the LPS control procedure of the power conversion circuit in one embodiment of the present invention. In one embodiment, the power conversion circuit starts operation at step S10 and enters an LPS control procedure P100. The LPS control procedure P100 includes: a first determination step S101 and an LPS operation S102. The first determination step S101 includes: determining whether the current sensing voltage Vcs is lower than a sensing threshold Vcsth, and whether an absolute value of the determination voltage Vx is higher than an absolute value of a determination threshold Vxth. The LPS operation S102 includes limiting an output power related to the current Iout. In one embodiment, when the result of the first determination step S101 is affirmative, i.e., the current sensing voltage Vcs is lower than the sensing threshold Vcsth and the absolute value of the determination voltage Vx is higher than the absolute value of the determination threshold Vxth, the LPS operation S102 is performed. In another embodiment, if the result of the first determination step S101 is negative, the step S101 is repeated until the result becomes affirmative, and then the LPS operation S102 is performed.

In one embodiment, the sensing threshold Vcsth corresponds to a current sensing threshold Ithcs, and the absolute value of the determination threshold Vxth corresponds to an absolute value of a current determination threshold Ithx. When the current sensing voltage Vcs is lower than Vcsth, it indicates that the current Iout is lower than the current sensing threshold Ithcs. When the absolute value of the determination voltage Vx is higher than the absolute value of the determination threshold Vxth, it indicates that the current Iout is higher than the current determination threshold Ithx. In one embodiment, the current sensing threshold Ithcs is lower than the absolute value of the current determination threshold Ithx.

FIG. 2B illustrates a flowchart of an LPS (Limit Power Source) control procedure of the power conversion circuit in another embodiment of the present invention. As shown in FIG. 2B, in one embodiment, the LPS control procedure P100 further includes a first delay operation S103. The first delay operation S103 includes waiting for a first delay time Td1. When the result of the first determination step S101 is affirmative, the first delay operation S103 is further performed. In this embodiment, the LPS operation S102 is performed after the first delay operation S103. By introducing the delay time Td1, noise interference can be reduced, thereby improving the debouncing effectiveness. For steps in FIG. 2B that are not described, please refer to the description of FIG. 2A.

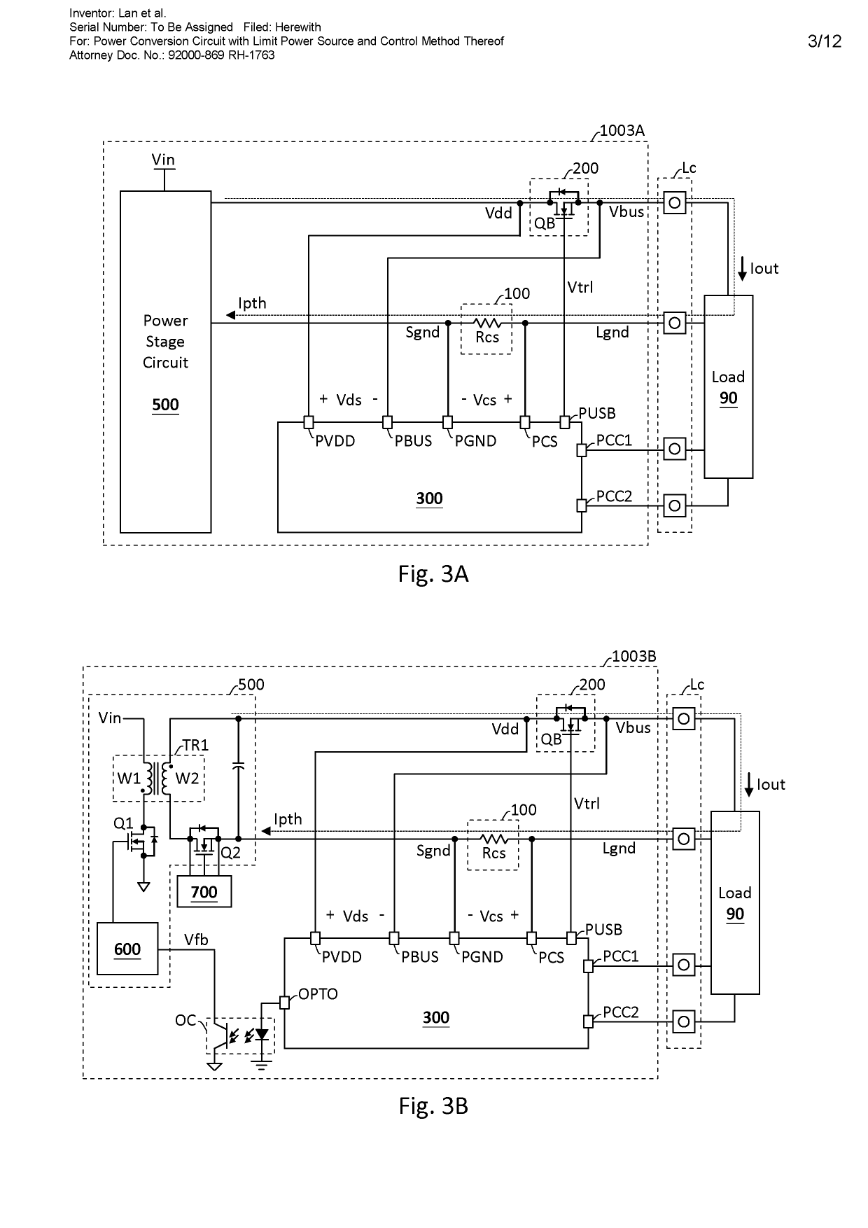

FIG. 3A illustrates a schematic diagram of a power conversion circuit in one embodiment of the present invention. The power conversion circuit 1003A in FIG. 3A corresponds to one embodiment of the power conversion circuit 1001A shown in FIG. 1A. In one embodiment, the power control circuit 300 of the power conversion circuit 1003A is implemented as an integrated circuit (same for the following embodiments). In a specific embodiment, the power control circuit 300 includes a power pin PVDD, a bus pin PBUS, a ground pin PGND, a sensing pin PCS, a control pin PUSB, and channel pins PCC1 and PCC2, which are coupled to corresponding pins of the load 90 via a connecting unit Lc in a removable manner, for example. The connecting unit Lc may correspond to a USB Type-C connector and/or cable.

In one embodiment, the power pin PVDD is configured to receive the supply voltage Vdd from the power stage circuit 500 and provide power for internal circuits of the power control circuit 300. The bus pin PBUS is configured to detect the bus voltage Vbus. The ground pin PGND provides a ground potential Sgnd for the power control circuit 300. The sensing pin PCS is coupled to the ground potential Lgnd and configured to receive the current sensing voltage Vcs generated by the sensing resistor Rcs, thereby sensing the current Iout flowing through the load 90. The control pin PUSB is configured to output a control signal Vtrl for controlling the path control switch QB. The channel pins PCC1 and PCC2 correspond to the configuration channel pins CC1 and CC2 of a USB Type-C interface, and are used for plug orientation detection and communication link establishment.

As shown in FIG. 3A, in one embodiment, the first current sensing circuit 100 (sensing resistor Rcs) has a first end and a second end coupled to a first pair of pins of the power control circuit 300. In this embodiment, the first pair of pins correspond to the sensing pin PCS and the ground pin PGND. The second current sensing circuit 200 corresponds to the path control switch QB. The first end and the second end of the second current sensing circuit 200 (i.e., the path control switch QB) are coupled to a second pair of pins of the power control circuit 300. In the embodiment of FIG. 3A, the power control circuit 300 is in the first configuration: when the second current sensing circuit 200 generates the determination voltage Vx via the path control switch QB, the second pair of pins correspond to the power pin PVDD and the bus pin PBUS of the power control circuit 300.

In a specific embodiment, the path control switch QB is implemented as an N-type metal-oxide semiconductor (MOS) transistor (same for subsequent embodiments). In the embodiment of FIG. 3A, the first terminal (drain) of the path control switch QB is coupled to the power pin PVDD, the second terminal (source) is coupled to the bus pin PBUS, and the control terminal (gate) is coupled to the control pin PUSB of the power control circuit 300. In this embodiment, the determination voltage Vx corresponds to the conduction voltage of the path control switch QB when turned on, i.e., the drain-source voltage when QB is conducting. It should be noted that the path control switch QB has a non-zero on-resistance when conducting. In this embodiment, the conduction voltage Vds of the path control switch QB corresponds to the product of the current Iout and the on-resistance of QB.

Referring also to FIGS. 2A, 2B, and 3A, in one embodiment, the LPS operation S102 includes turning off the path control switch QB or increasing the on-resistance of the path control switch QB (i.e., reducing its conduction or drive capability). Specifically, in this embodiment, by lowering the voltage of the control signal Vtrl, the gate voltage of the NMOS transistor QB is reduced, thereby turning off QB or increasing its on-resistance to achieve the LPS effect.

FIG. 3B illustrates a schematic diagram of a power conversion circuit in one embodiment of the present invention. The power conversion circuit 1003B in FIG. 3B corresponds to a specific embodiment of the power conversion circuit 1003A shown in FIG. 3A. As shown in FIG. 3B, in one embodiment, the power conversion circuit 1003B is configured as a flyback power conversion circuit. The power stage circuit 500 includes a transformer TR, a primary-side switch Q1, a primary-side control circuit 600, and a rectifier switch Q2. The transformer TR includes a primary winding W1 and a secondary winding W2. The primary winding W1 is coupled to the input voltage Vin, and the secondary winding W2 is coupled to the supply voltage Vdd. The primary-side control circuit 600 controls the primary-side switch Q1 coupled to the primary winding W1 according to a feedback signal Vfb, thereby switching W1 to convert Vin to the supply voltage Vdd at the secondary side. In one embodiment, the rectifier switch Q2 is serially coupled to the current path Ipth of current Iout. Specifically, the rectifier switch Q2 is coupled between the sensing resistor Rcs and the secondary winding W2. A rectifier control circuit 700 is configured to control the rectifier switch Q2 for synchronous rectification on the secondary side. In one embodiment, the power control circuit 300 further includes a coupling pin OPTO, configured to receive feedback from the supply voltage Vdd and generate the feedback signal Vfb to the primary-side control circuit 600 via an opto-coupler OC. For other aspects of FIG. 3B not described here, please refer to the description of FIG. 3A.

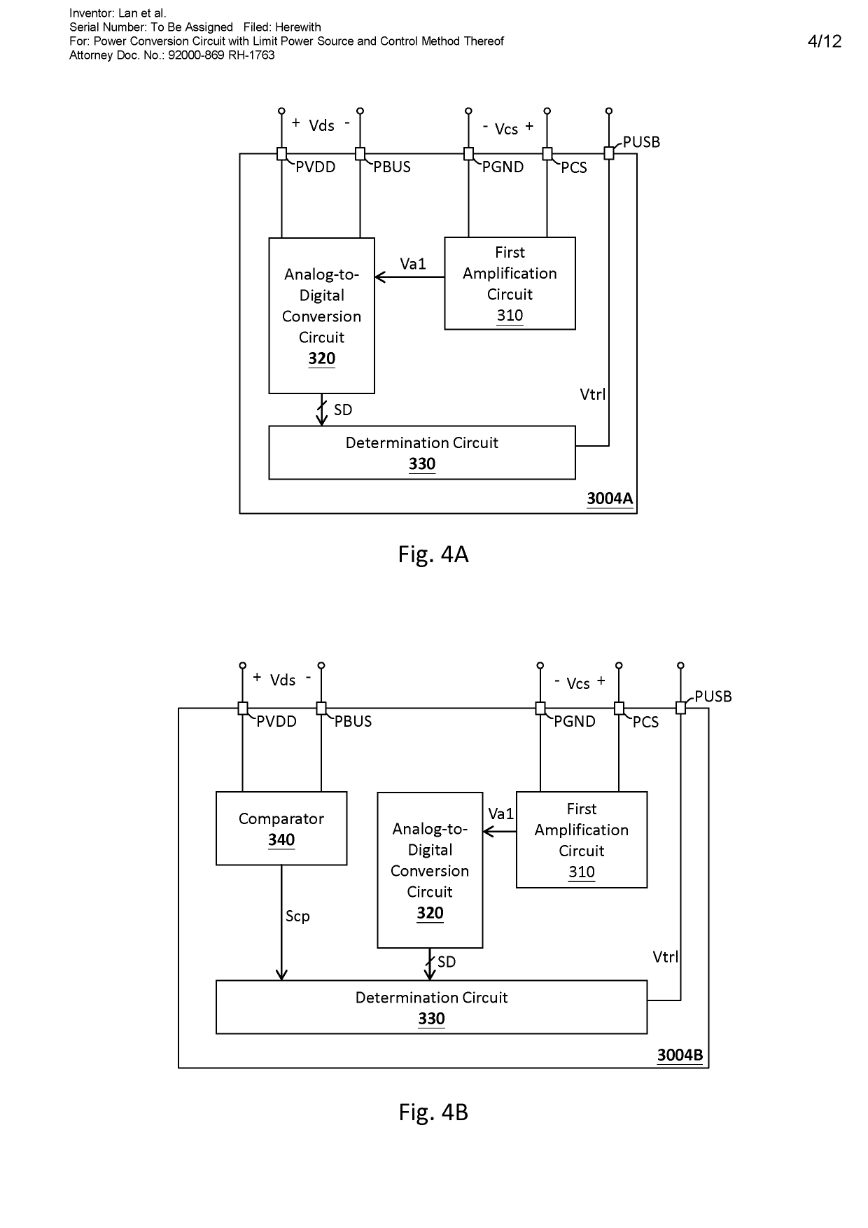

FIG. 4A illustrates a schematic diagram of a power control circuit in one embodiment of the present invention. The power control circuit 3004A in FIG. 4A corresponds to a specific embodiment of the power control circuit 300 in FIG. 3A. As shown in FIG. 4A, in one embodiment, the power control circuit 3004A includes a first amplification circuit 310, an analog-to-digital conversion circuit 320, and a determination circuit 330. The first amplification circuit 310 is coupled to the first pair of pins (i.e., the sensing pin PCS and ground pin PGND) and is configured to amplify the current sensing voltage Vcs to generate a first amplified signal Va1. The analog-to-digital conversion circuit 320 is configured to convert the first amplified signal Va1 into a first digital amplified signal in the digital domain.

In one embodiment, the analog-to-digital conversion circuit 320 is further coupled to the second pair of pins (corresponding to PVDD and PBUS in this case), and is configured to convert the determination voltage Vx (i.e., the conduction voltage Vds) into a second digital amplified signal in the digital domain. The analog-to-digital conversion circuit 320 generates a digital output signal SD based on the first and second digital amplified signals. The determination circuit 330 is configured to perform the LPS control procedure P100 based on the digital output signal SD (including both the first and the second digital amplified signals). In other words, the determination circuit 330 performs the LPS control procedure P100 based on the first digital amplified signal and the determination voltage Vx (conduction voltage Vds). In a specific embodiment, the determination circuit 330 corresponds to a microcontroller unit (MCU). In this embodiment, the comparison in the first determination step S101 can be performed in the digital domain by the determination circuit 330.

It should be noted that, in one embodiment, the analog-to-digital conversion circuit 320 performs the conversion in two conversion periods: it converts the first amplified signal Va1 to generate the first digital amplified signal in the first conversion period, and converts the conduction voltage Vds to generate the second digital amplified signal in the second conversion period, thereby generating the digital output signal SD accordingly. In one embodiment, the digital output signal SD corresponds to the first digital amplified signal in the first conversion period and to the second digital amplified signal in the second conversion period. That is, the analog-to-digital conversion circuit 320 is time-shared to perform the conversion operations. In other embodiments, the analog-to-digital conversion circuit 320 may include multiple sub-ADC circuits to simultaneously convert Va1 and Vds, generating multiple sub-digital output signals as parts of SD in parallel.

FIG. 4B illustrates a schematic diagram of a power control circuit in one embodiment of the present invention. The power control circuit 3004B in FIG. 4B corresponds to another specific embodiment of the power control circuit 300 in FIG. 3A. The power control circuit 3004B is similar to that shown in FIG. 4A, with differences as described below. As shown in FIG. 4B, in one embodiment, the power control circuit 3004B further includes a comparator 340 configured to compare the conduction voltage Vds with the determination threshold Vxth to generate a comparison signal Scp. The determination circuit 330 is further configured to perform the LPS control procedure P100 based on the first digital amplified signal and the comparison signal Scp. It should be noted that in the embodiment of FIG. 4B, the digital output signal SD generated by the analog-to-digital conversion circuit 320 corresponds to the first digital amplified signal.

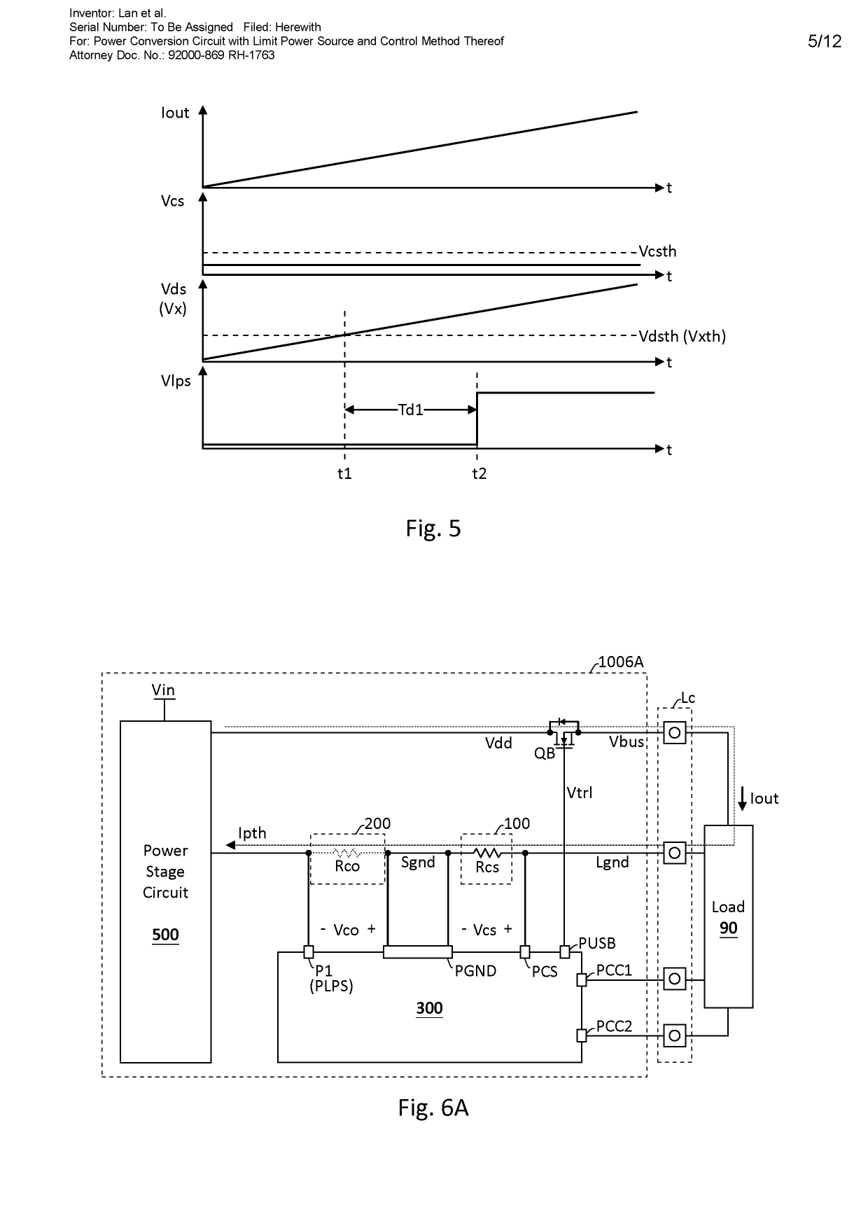

Referring also to FIGS. 2B, 3A, and 5, FIG. 5 illustrates a waveform diagram of the power conversion circuit corresponding to the embodiment in FIG. 3A. In this embodiment, the determination voltage Vx corresponds to the conduction voltage Vds of the path control switch QB, and the determination threshold Vxth corresponds to a conduction voltage threshold Vdsth. As shown in FIG. 5, the current Iout increases over time. At time t1, the current sensing voltage Vcs is lower than the sensing threshold Vcsth, and the absolute value of the determination voltage Vx is higher than the absolute value of the determination threshold Vxth. In this embodiment, the result of the first determination step S101 at time t1 is affirmative. At this moment, the first delay operation S103 is performed, i.e., waiting for the first delay time Td1. Subsequently, at time t2, an LPS indication signal Vlps transitions to a high level, indicating that the LPS operation S102 is performed.

It should be noted that, in one embodiment, as shown in FIG. 5, the current Iout gradually increases over time, and the determination voltage Vx also increases accordingly. However, the current sensing voltage Vcs does not increase with Iout but remains below the sensing threshold Vcsth. These two conflicting messages suggest that the sensing resistor Rcs may be malfunctioning and thus unable to operate properly. Through the first determination step S101 of the LPS control procedure P100, when the current sensing voltage Vcs is lower than the sensing threshold Vcsth and the absolute value of the determination voltage Vx is higher than that of the determination threshold Vxth, the LPS operation S102 is performed—or alternatively, the operation is performed after waiting for the first delay time Td1. This limits the output power associated with Iout to achieve the LPS protection objective, preventing continuous current rise due to the failure of Rcs and avoiding potential damage to the load 90.

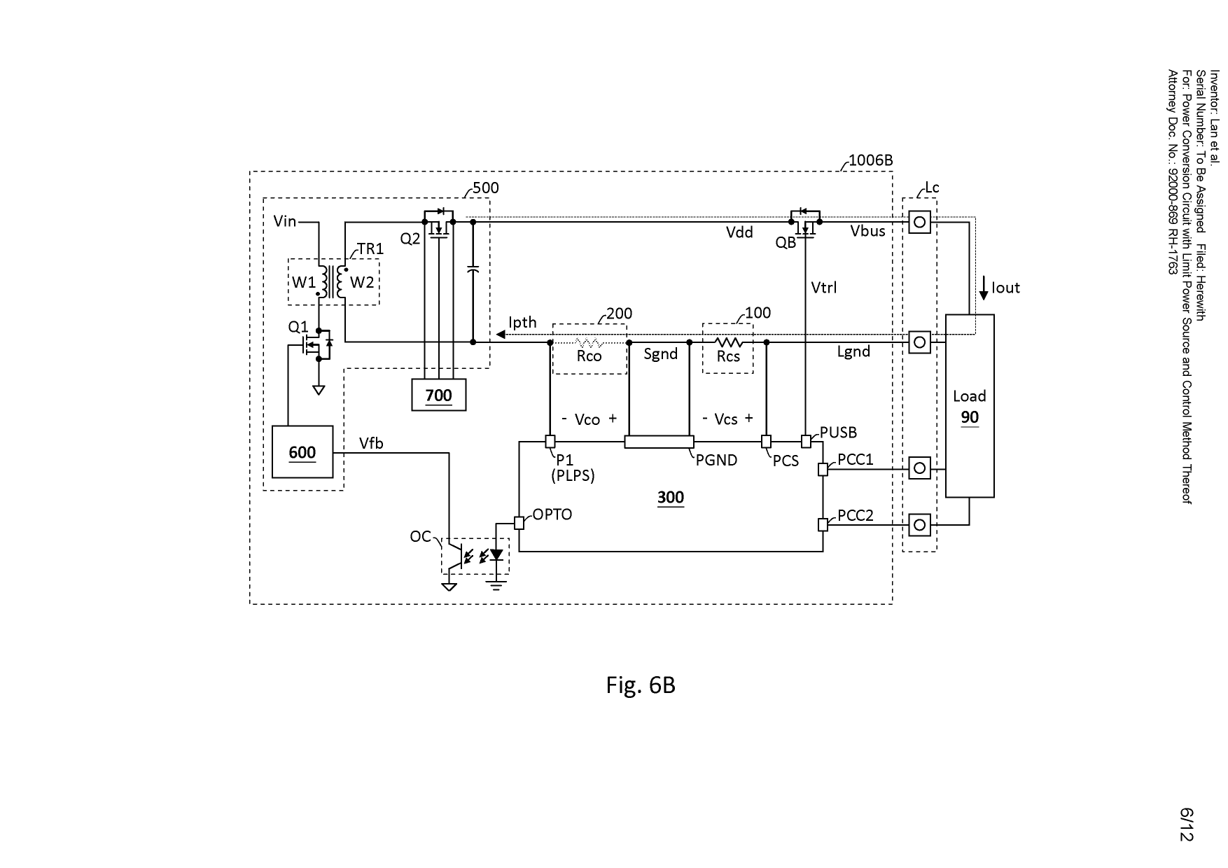

FIG. 6A illustrates a schematic diagram of a power conversion circuit in one embodiment of the present invention. The power conversion circuit 1006A in FIG. 6A corresponds to one embodiment of the power conversion circuit 1001B in FIG. 1B. In a specific embodiment, the power control circuit 300 of the power conversion circuit 1006A includes a first pin P1, a ground pin PGND, a sensing pin PCS, a control pin PUSB, and channel pins PCC1 and PCC2, wherein the sensing pin PCS and the channel pins PCC1 and PCC2 are coupled to the load 90 via a connecting unit Lc.

As shown in FIG. 6A, in one embodiment, the second current sensing circuit 200 corresponds to a conductive trace segment (shown as a gray line in FIG. 6A). The first and second ends of the second current sensing circuit 200 (i.e., the conductive trace segment) are coupled to a second pair of pins of the power control circuit 300. In the embodiment of FIG. 6A, the power control circuit 300 is in the second configuration: when the second current sensing circuit 200 generates the determination voltage Vx via the conductive trace segment, the second pair of pins correspond to the ground pin PGND and the first pin P1. In a specific embodiment, the first end of the conductive trace segment is coupled to PGND, and the second end is coupled to P1. In this embodiment, the determination voltage Vx corresponds to a cross-voltage Vco across the first and second ends of the conductive trace segment. Specifically, the conductive trace segment has a non-zero trace resistance Rco, and the determination voltage Vx (i.e., Vco) corresponds to the product of Rco and Iout.

In the embodiment of FIG. 6A, the first pin P1 corresponds to an LPS pin PLPS. The LPS pin PLPS is configured to receive the determination voltage Vx (i.e., Vco) for performing the LPS control procedure P100. For additional details not described here, please refer to FIG. 3A.

FIG. 6B illustrates a schematic diagram of a power conversion circuit in one embodiment of the present invention. The power conversion circuit 1006B in FIG. 6B corresponds to a specific embodiment of the power conversion circuit 1006A in FIG. 6A. As shown in FIG. 6B, in one embodiment, the power conversion circuit 1006B is configured as a flyback power conversion circuit. In one embodiment, the rectifier switch Q2 of the power stage circuit 500 is coupled to the path control switch QB. For operation details not described in FIG. 6B, please refer to FIGS. 3B and 6A.

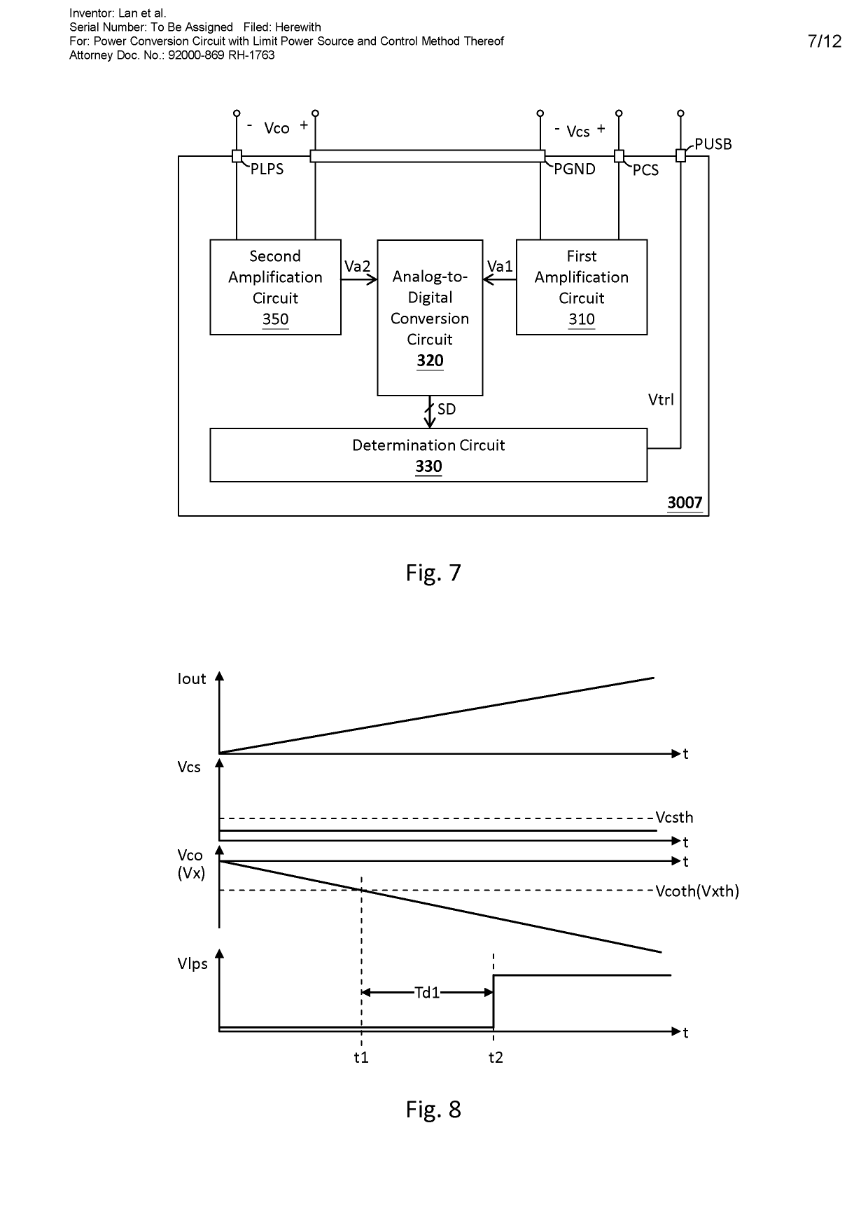

FIG. 7 illustrates a schematic diagram of a power control circuit in one embodiment of the present invention. The power control circuit 3007 in FIG. 7 corresponds to a specific embodiment of the power control circuit 300 in FIG. 6A. The power control circuit 3007 is similar to the power control circuit 3004A in FIG. 4A, and the differences are described below. As shown in FIG. 7, in one embodiment, the power control circuit 3007 further includes a second amplification circuit 350 coupled to the second pair of pins (i.e., PLPS and PGND) for amplifying the cross-voltage Vco of the conductive trace segment via the second pair of pins to generate a second amplified signal Va2. The analog-to-digital conversion circuit 320 is further configured to convert the second amplified signal Va2 to generate a third digital amplified signal in the digital domain. The determination circuit 330 is further configured to perform the LPS control procedure P100 based on the digital output signal SD (i.e., the first and third digital amplified signals).

It should be noted that, in one embodiment, the analog-to-digital conversion circuit 320 performs conversion in the first and second conversion periods. It converts the first amplified signal Va1 to generate the first digital amplified signal in the first period, and converts the second amplified signal Va2 to generate the third digital amplified signal in the second period. Accordingly, the digital output signal SD is generated based on either the first or third digital amplified signal. In other words, the digital output signal SD corresponds to the first digital amplified signal during the first period and to the third digital amplified signal during the second period. For further operation details not described here, please refer to FIG. 4A.

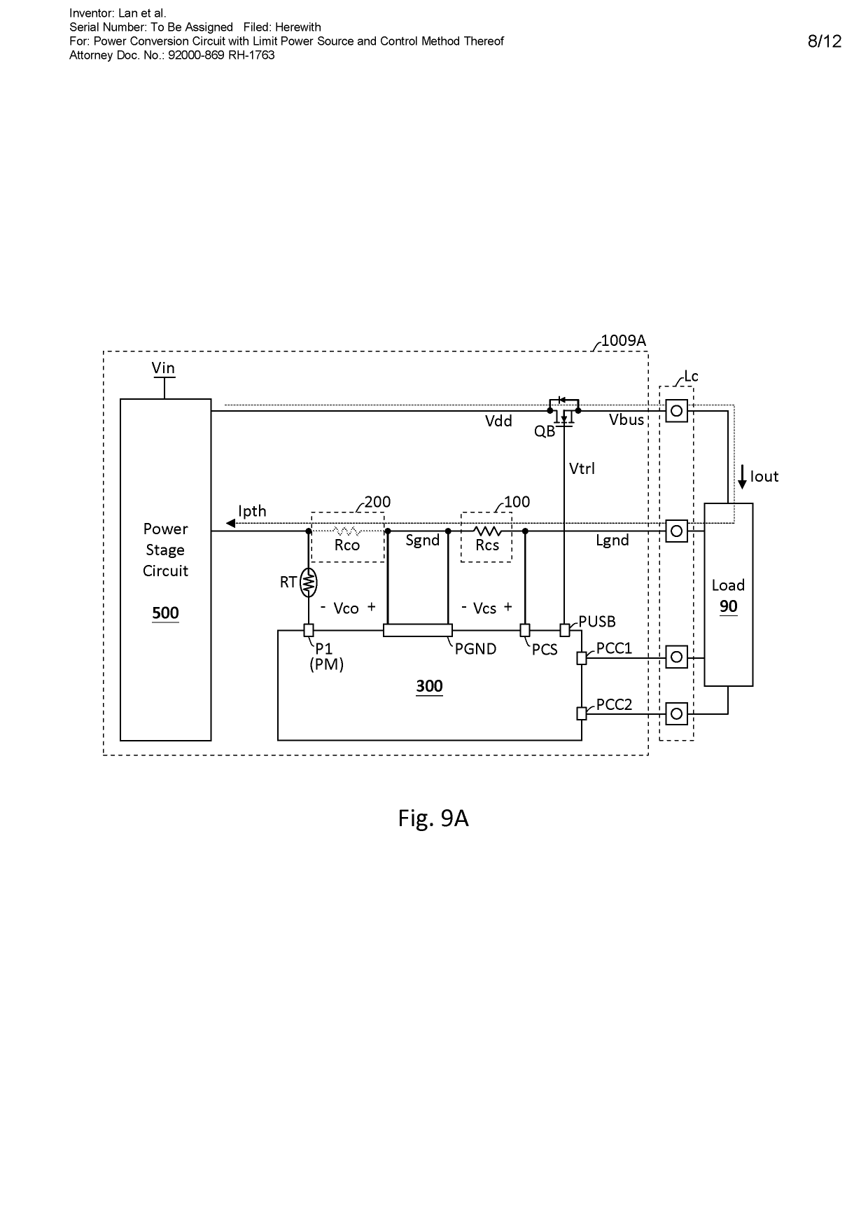

Referring also to FIGS. 2B, 6A, and 8, FIG. 8 illustrates a waveform diagram of the power conversion circuit corresponding to the embodiment in FIG. 6A. In one embodiment, as shown in FIG. 8, the current Iout increases over time. At time t1, the current sensing voltage Vcs is lower than the sensing threshold Vcsth, and the absolute value of the determination voltage Vx is higher than that of the determination threshold Vxth. In the embodiment of FIG. 6A, the determination voltage Vx corresponds to the cross-voltage Vco across the conductive trace segment, and the determination threshold Vxth corresponds to a cross-voltage threshold Vcoth. In this embodiment, the result of the first determination step S101 at time t1 is affirmative. At this point, the first delay operation S103 is performed, i.e., waiting for delay time Td1. Subsequently, at time t2, the LPS indication signal Vlps transitions to a high level, indicating that the LPS operation S102 is performed. It should be noted that, in the embodiment of FIG. 6A, the cross-voltage Vco is negative (i.e., less than 0), and the cross-voltage threshold Vcoth is also negative. As shown in FIG. 8, Vco decreases as Iout increases.

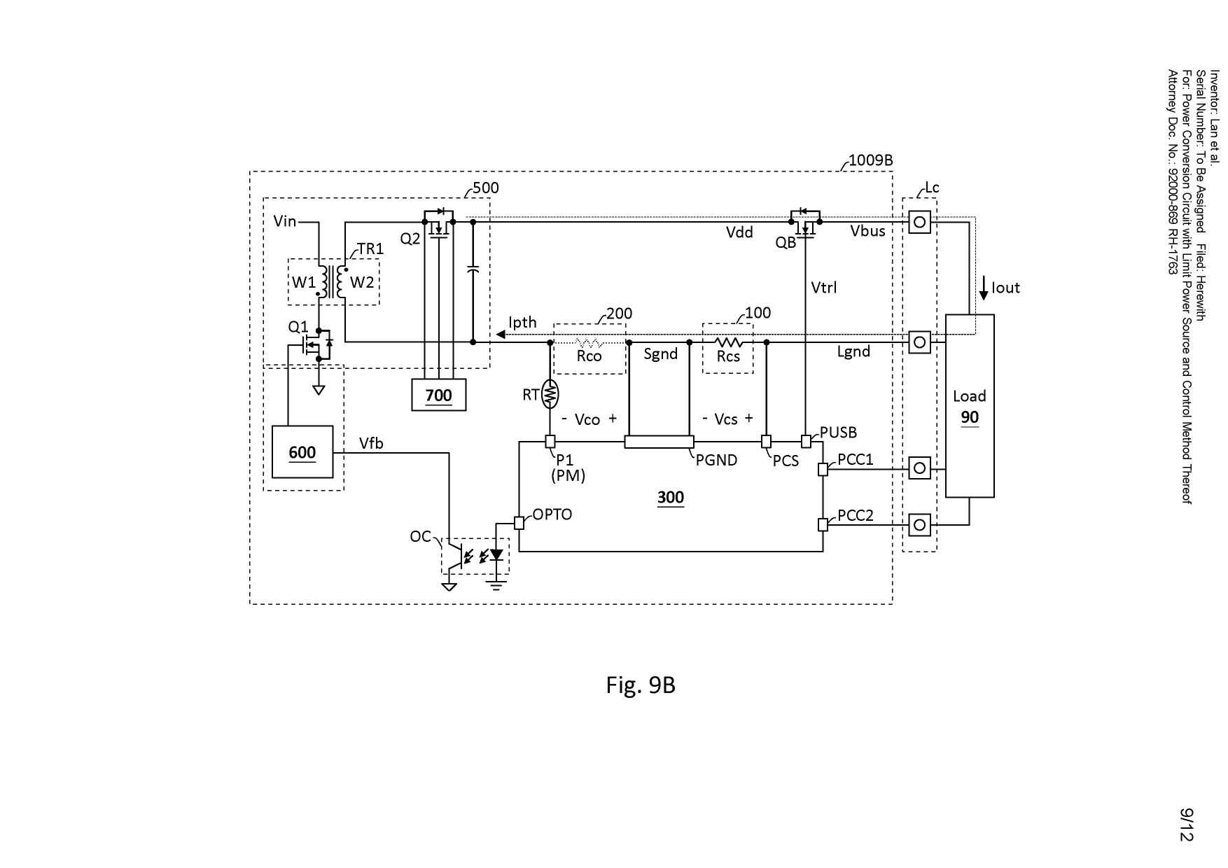

FIG. 9A illustrates a schematic diagram of a power conversion circuit in one embodiment of the present invention. The power conversion circuit 1009A in FIG. 9A corresponds to one embodiment of the power conversion circuit 1001B in FIG. 1B. The circuit 1009A is similar to the circuit 1006A in FIG. 6A, and the differences are described as follows. As shown in FIG. 9A, in one embodiment, the second end of the conductive trace segment is further coupled to the first pin P1 via a temperature sensing resistor RT. In this embodiment, the first pin P1 corresponds to a multiplexed pin PM (hereinafter referred to as multiplexed pin PM). In one embodiment, the power control circuit 300 is configured to receive the cross-voltage Vco of the conductive trace segment through the multiplexed pin PM during a first period to perform the LPS control procedure P100, and to provide a bias current to the temperature sensing resistor RT through PM during a second period to perform over-temperature protection operations. Detailed descriptions are provided later. For any operation details not mentioned here, please refer to FIG. 6A.

FIG. 9B illustrates a schematic diagram of a power conversion circuit in one embodiment of the present invention. The power conversion circuit 1009B in FIG. 9B corresponds to a specific embodiment of the power conversion circuit 1009A in FIG. 9A. As shown in FIG. 9B, in one embodiment, the power conversion circuit 1009B is configured as a flyback power conversion circuit. Those skilled in the art may infer the operational details of FIG. 9B from the aforementioned descriptions.

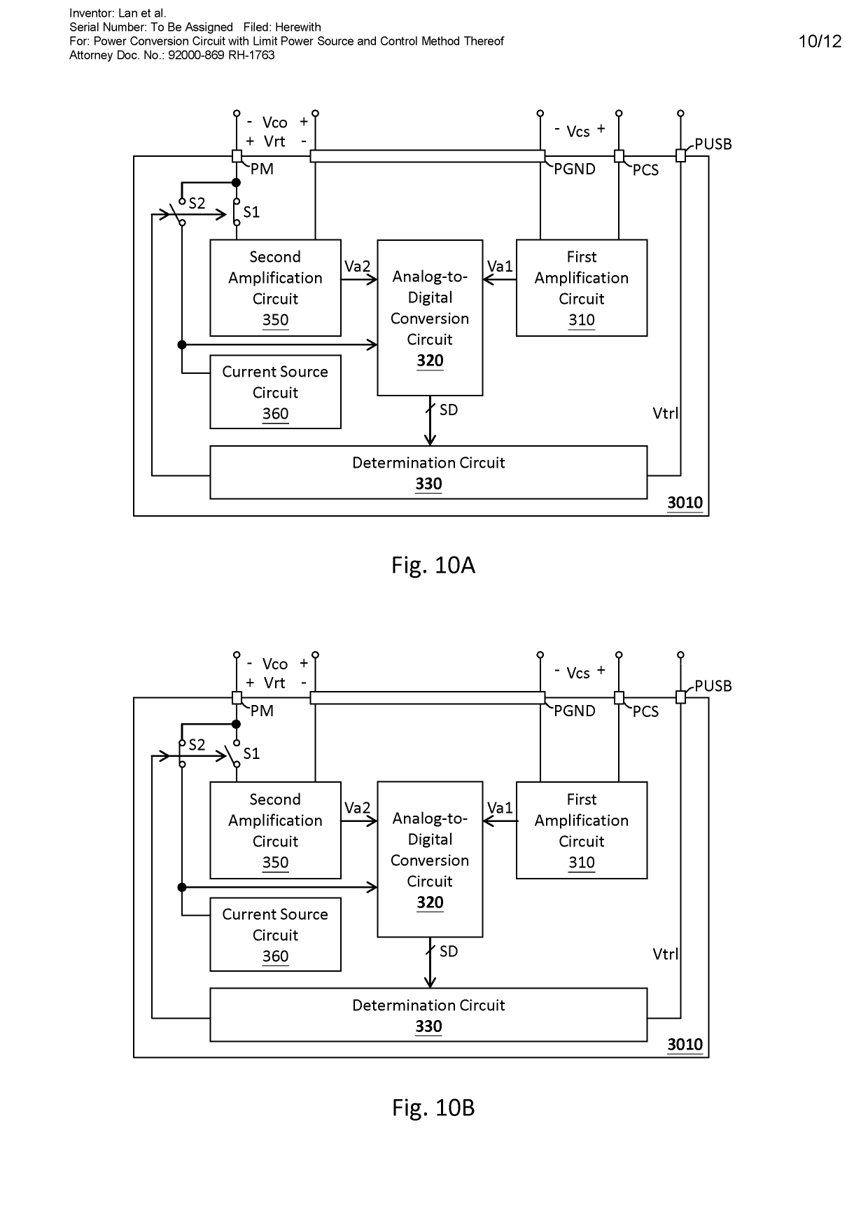

FIGS. 10A and 10B illustrate schematic diagrams of a power control circuit of the power conversion circuit in different periods, in one embodiment of the present invention. The power control circuit 3010 shown in FIGS. 10A and 10B corresponds to a specific embodiment of the power control circuit 300 shown in FIG. 9A. The power control circuit 3010 is similar to the power control circuit 3007 in FIG. 7, and the differences are described below. As shown in FIGS. 10A and 10B, in one embodiment, the power control circuit 3010 further includes a current source circuit 360, a first signal path switch S1, and a second signal path switch S2. The current source circuit 360 is configured to provide a bias current. The first signal path switch S1 is coupled between the multiplexed pin PM and the second amplification circuit 350. The second signal path switch S2 is coupled between the multiplexed pin PM and the current source circuit 360.

As shown in FIG. 10A, in one embodiment, during a first period, the first signal path switch S1 is turned on, and the second signal path switch S2 is turned off. The second amplification circuit 350 receives the cross-voltage Vco of the conductive trace segment through the first signal path switch S1 and the multiplexed pin PM. The determination circuit 330 is configured to perform the LPS control procedure based on the digital output signal SD (i.e., the first and third digital amplified signals). Other operations in the first period are the same as those described in FIG. 7.

As shown in FIG. 10B, in one embodiment, during a second period, the first signal path switch S1 is turned off and the second signal path switch S2 is turned on. The current source circuit 360 provides a bias current to the temperature sensing resistor RT through the second signal path switch S2 and the multiplexed pin PM, thereby generating a cross-voltage Vrt across temperature sensing resistor RT. During the second period, the analog-to-digital conversion circuit 320 further converts the cross-voltage Vrt into a digital temperature sensing signal in the digital domain. The determination circuit 330 is further configured to determine whether the temperature of the temperature sensing resistor RT is higher than an over-temperature protection threshold based on the digital temperature sensing signal, and to perform an over-temperature protection operation when the temperature is higher than the over-temperature protection threshold.

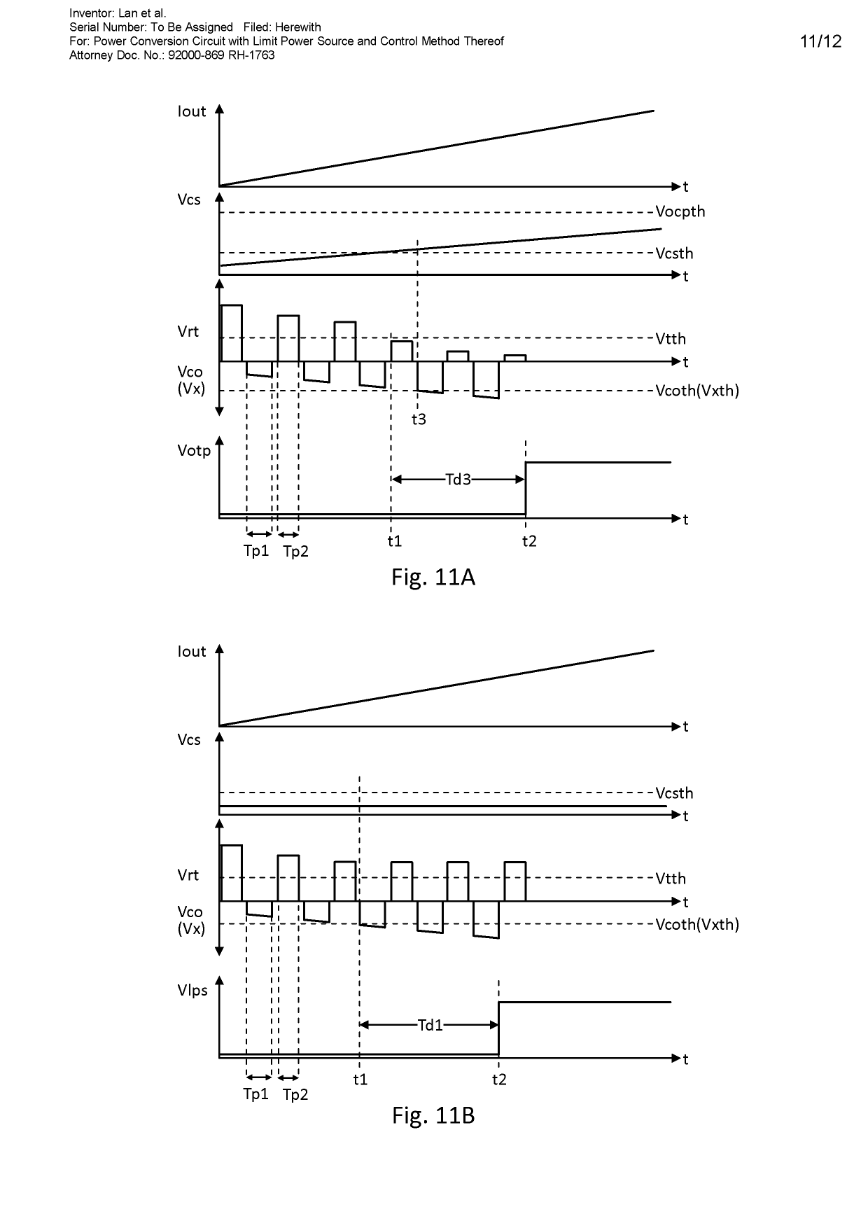

Referring also to FIGS. 2B, 9A, and 11A, FIG. 11A illustrates a waveform diagram of the power conversion circuit corresponding to the embodiment in FIG. 9A. In the embodiment of FIG. 11A, the determination voltage Vx corresponds to the cross-voltage Vco of the conductive trace segment, and the determination threshold Vxth corresponds to a cross-voltage threshold Vcoth. As shown in FIG. 11A, the current Iout gradually increases over time. At time t3, the current sensing voltage Vcs is higher than the sensing threshold Vcsth, and the absolute value of the determination voltage Vx is higher than that of the determination threshold Vxth. In this embodiment, the result of the first determination step S101 at time t3 is negative. Therefore, the step S101 is repeated, and neither the first delay operation S103 nor the LPS operation S102 is performed.

It should be noted that in the embodiment of FIG. 11A, the current Iout increases over time, and the current sensing voltage Vcs also increases, indicating that the sensing resistor Rcs is operating normally. In this state, the power control circuit 300 operates in a standard control mode, determining whether to perform overcurrent protection based on a comparison between Vcs and the overcurrent threshold voltage Vocpth. As shown in FIG. 11A, Vcs does not exceed Vocpth, and therefore overcurrent protection is not activated. It is further noted that in the embodiment of FIG. 9A, the multiplexed pin PM is used for current sensing during a first period (e.g., Tp1 and subsequent corresponding periods) and for temperature sensing during a second period (e.g., Tp2 and its corresponding periods). As a result, in the waveform diagram of FIG. 11A, the cross-voltage Vco from the conductive trace segment and the cross-voltage Vrt from the temperature sensing resistor RT received via PM are non-continuous waveforms. It should also be noted that, in one embodiment, the resistance of the temperature sensing resistor RT within a sensing temperature range to be sensed is significantly higher than the trace resistance Rco of the conductive trace segment (e.g., over 100 times).

Referring also to FIGS. 9A and 11A, in a specific embodiment, the temperature sensing resistor RT has a negative temperature coefficient. A lower cross-voltage Vrt across RT indicates a higher temperature. As shown in FIG. 11A, in one embodiment, at time t1, the cross-voltage Vrt is lower than the temperature threshold Vtth. After a third delay time Td3, the over-temperature indication signal Votp transitions to a high level, indicating that over-temperature protection is activated.

Referring also to FIGS. 2B, 9A, and 11B, FIG. 11B illustrates a waveform diagram of the power conversion circuit corresponding to the embodiment in FIG. 9A, in another embodiment of the present invention. In the embodiment of FIG. 11B, the determination voltage Vx corresponds to the cross-voltage Vco of the conductive trace segment, and the determination threshold Vxth corresponds to a cross-voltage threshold Vcoth. As shown in FIG. 11B, at time t1, the current sensing voltage Vcs is lower than the sensing threshold Vcsth, and the absolute value of the determination voltage Vx is higher than that of the determination threshold Vxth. In this embodiment, the result of the first determination step S101 at time t1 is affirmative. The first delay operation S103 is performed, i.e., the system waits for the first delay time Td1. Subsequently, at time t2, the LPS indication signal Vlps transitions to a high level, indicating that the LPS operation S102 is performed.

In this embodiment of FIG. 11B, the cross-voltage Vrt of the temperature sensing resistor RT does not fall below the temperature threshold Vtth; thus, over-temperature protection is not activated. It should be noted that the term "exceeds" herein, when the temperature sensing resistor RT has a negative temperature coefficient, refers to the condition where the cross-voltage Vrt across RT decreases and falls below the temperature threshold Vtth. In contrast, when RT has a positive temperature coefficient, "exceeds" refers to the condition where the cross-voltage Vrt increases and rises above the temperature threshold Vtth. In both cases, it indicates that the temperature of the temperature sensing resistor RT is higher than the over-temperature protection threshold.

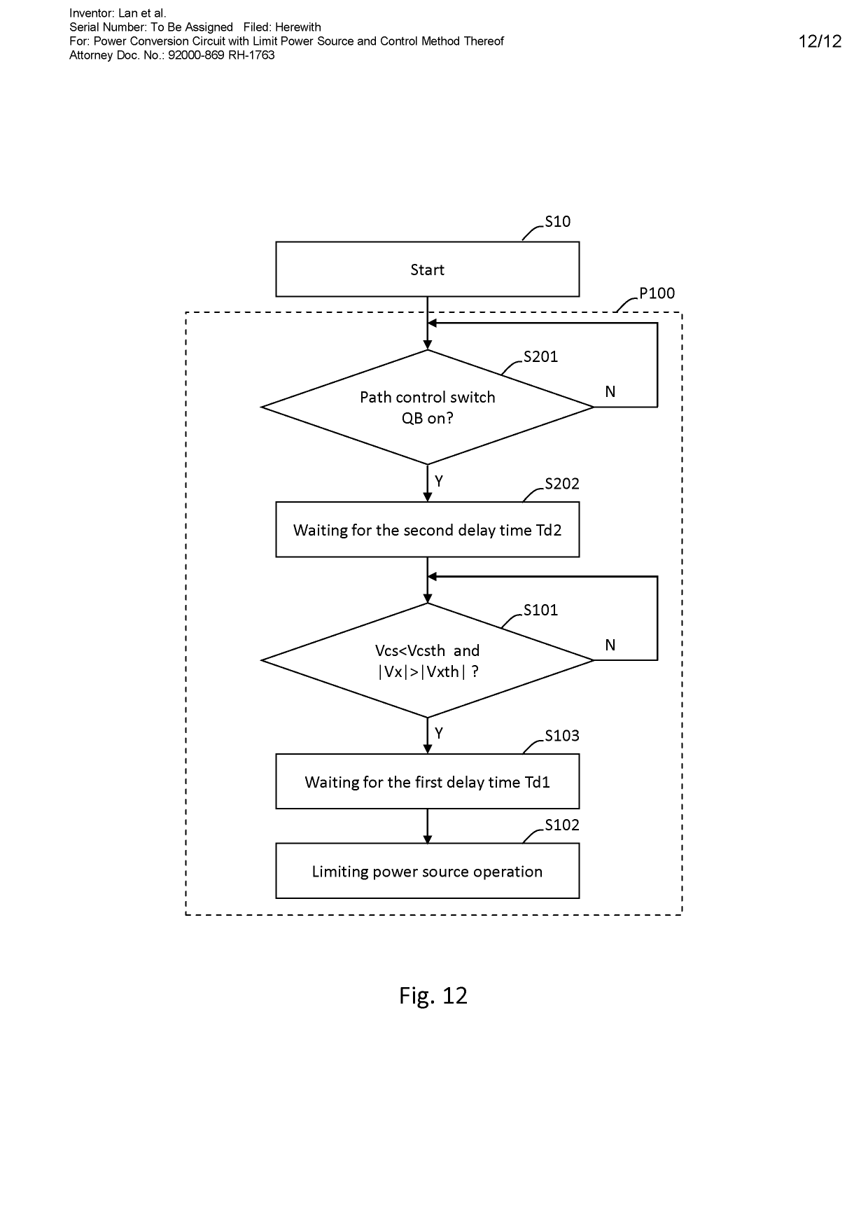

FIG. 12 illustrates a flowchart of an LPS control procedure of the power conversion circuit in one embodiment of the present invention. The flowchart in FIG. 12 is similar to that of FIG. 2B, and the differences are described below. In one embodiment, the LPS control procedure P100 further includes a second determination step S201 and a second delay operation S202. The second determination step S201 includes determining whether the path control switch QB is turned on. The second delay operation S202 includes waiting for a second delay time Td2.

In one embodiment, when the result of the second determination step S201 is affirmative, the second delay operation S202 is performed. In another embodiment, when the result of the second determination step S201 is negative, the step S201 is repeated until the result becomes affirmative, and then the second delay operation S202 is subsequently performed. In this embodiment, the first determination step S101 is executed after the second determination step S201 and, more specifically, after the second delay operation S202.

It should be noted that the operation flow of FIG. 12 is applicable to all the embodiments described above. It should also be noted that, since the current path Ipth is established when the path control switch QB is turned on, the flowchart in FIG. 12 ensures the proper operation of the LPS control procedure P100.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. In view of the foregoing, the spirit of the present invention should cover all such and other modifications and variations, which should be interpreted to fall within the scope of the following claims and their equivalents.

What is claimed is:

1. A power conversion circuit configured to generate a supply voltage according to an input voltage, comprising:
a path control switch coupled between the supply voltage and a bus voltage, configured to control a conduction path of the supply voltage to the bus voltage, wherein the bus voltage is configured to provide a current to a load;
a first current sensing circuit including a sensing resistor serially coupled to a current path of the current, configured to generate a current sensing voltage according to the current;
a second current sensing circuit including the path control switch or a conductive trace segment, wherein the path control switch or the conductive trace segment is serially coupled to the current path, configured to generate a determination voltage according to the current; and
a power control circuit configured to control the path control switch and perform a limit power source (LPS) control procedure according to the current sensing voltage and the determination voltage;
wherein the LPS control procedure includes:
a first determination step of determining whether the current sensing voltage is lower than a sensing threshold and whether an absolute value of the determination voltage is higher than an absolute value of a determination threshold; and
an LPS operation configured to limit an output power related to the current;
wherein when a result of the first determination step is affirmative, the LPS operation is performed.

2. The power conversion circuit of claim 1, wherein the power control circuit is implemented as an integrated circuit; wherein a first end and a second end of the first current sensing circuit are coupled to a first pair of pins of the power control circuit, the first pair of pins corresponding to a sensing pin and a ground pin of the power control circuit; wherein a first end and a second end of the second current sensing circuit are coupled to a second pair of pins of the power control circuit; wherein the power control circuit is configured in one of the following:
a first configuration, in which when the second current sensing circuit generates the determination voltage by the path control switch, the second pair of pins correspond to a power pin and a bus pin of the power control circuit, a first terminal of the path control switch is coupled to the power pin, a second terminal of the path control switch is coupled to the bus pin, a control terminal of the path control switch is coupled to a control pin of the power control circuit, and the determination voltage corresponds to a conduction voltage of the path control switch when turned on; or
a second configuration, in which when the second current sensing circuit generates the determination voltage by the conductive trace segment, the second pair of pins correspond to the ground pin of the power control circuit and a first pin, a first end of the conductive trace segment is coupled to the ground pin, a second end of the conductive trace segment is coupled to the first pin, and the determination voltage corresponds to a cross-voltage between the first end and the second end of the conductive trace segment.

3. The power conversion circuit of claim 2, wherein the power control circuit includes:
a first amplification circuit coupled to the first pair of pins and configured to amplify the current sensing voltage to generate a first amplified signal;
an analog-to-digital conversion circuit configured to convert the first amplified signal to generate a first digital amplified signal in digital domain, and
a determination circuit configured to perform the LPS control procedure according to the first digital amplified signal and the determination voltage.

4. The power conversion circuit of claim 3, wherein when the power control circuit is in the first configuration, the analog-to-digital conversion circuit is further configured to convert the conduction voltage to generate a second digital amplified signal in digital domain, and the determination circuit is further configured to perform the LPS control procedure according to the first digital amplified signal and the second digital amplified signal; or
wherein when the power control circuit is in the first configuration, the power control circuit further includes a comparator configured to compare the conduction voltage with the determination threshold to generate a comparison signal, and the determination circuit is further configured to perform the LPS control procedure according to the first digital amplified signal and the comparison signal.

5. The power conversion circuit of claim 1, wherein the LPS control procedure further includes a first delay operation of waiting for a first delay time, and when a result of the first determination step is affirmative, the first delay operation is further performed and the LPS operation is subsequently performed.

6. The power conversion circuit of claim 1, wherein the LPS control procedure further includes a second determination step of determining whether the path control switch is turned on and a second delay operation of waiting for a second delay time, and when a result of the second determination step is affirmative, the second delay operation is subsequently performed and the first determination step is performed.

7. The power conversion circuit of claim 1, wherein the LPS operation includes turning off the path control switch or increasing an on-resistance of the path control switch.

8. The power conversion circuit of claim 1, wherein a current sensing threshold corresponding to the sensing threshold is lower than an absolute value of a current determination threshold corresponding to the determination threshold.

9. The power conversion circuit of claim 3, wherein when the power control circuit is in the second configuration, the power control circuit further includes a second amplification circuit configured to, through the second pair of pins, amplify the cross-voltage of the conductive trace segment to generate a second amplified signal;
wherein the analog-to-digital conversion circuit is further configured to convert the second amplified signal to generate a third digital amplified signal in digital domain, and the determination circuit is further configured to perform the LPS control procedure according to the first digital amplified signal and the third digital amplified signal.

10. The power conversion circuit of claim 9, wherein a second end of the conductive trace segment is further coupled to the first pin via a temperature sensing resistor, and the power control circuit further includes a current source circuit configured to provide a bias current;
wherein during a first period, the second amplification circuit receives the cross-voltage of the conductive trace segment through the first pin and the determination circuit is configured to perform the LPS control procedure according to the first digital amplified signal and the third digital amplified signal;
wherein during a second period, the current source circuit is configured to provide the bias current to the temperature sensing resistor through the first pin so as to generate a cross-voltage across the temperature sensing resistor;
wherein during the second period, the analog-to-digital conversion circuit is further configured to convert the cross-voltage of the temperature sensing resistor to generate a digital temperature sensing signal in digital domain; and
wherein during the second period, the determination circuit is further configured to determine whether a temperature of the temperature sensing resistor is higher than an over-temperature protection threshold according to the digital temperature sensing signal.

11. A control method for controlling a power conversion circuit configured to generate a supply voltage according to an input voltage, comprising:
controlling, by a path control switch, a conduction path of the supply voltage to a bus voltage, wherein the bus voltage is configured to provide a current to a load;
generating a current sensing voltage according to the current by a first current sensing circuit including a sensing resistor serially coupled to a current path of the current;
generating a determination voltage according to the current by a second current sensing circuit including the path control switch or a conductive trace segment serially coupled to the current path; and
performing an LPS control procedure according to the current sensing voltage and the determination voltage; wherein the LPS control procedure includes:
a first determination step of determining whether the current sensing voltage is lower than a sensing threshold and whether an absolute value of the determination voltage is higher than an absolute value of a determination threshold; and
an LPS operation configured to limit an output power related to the current;
wherein when a result of the first determination step is affirmative, the LPS operation is performed.

12. The control method of claim 11, further comprising:
amplifying the current sensing voltage to generate a first amplified signal;
converting the first amplified signal to generate a first digital amplified signal in digital domain, and
performing the LPS control procedure according to the first digital amplified signal and the determination voltage.

13. The control method of claim 12, wherein when the second current sensing circuit includes the path control switch serially coupled to the current path, the method further comprises:
converting a conduction voltage of the path control switch when turned on to generate a second digital amplified signal; and
performing the LPS control procedure according to the first digital amplified signal and the second digital amplified signal; or the method further comprises:
comparing the conduction voltage with the determination threshold to generate a comparison signal; and
performing the LPS control procedure according to the first digital amplified signal and the comparison signal.

14. The control method of claim 11, wherein the LPS control procedure further includes a first delay operation of waiting for a first delay time;
wherein when a result of the first determination step is affirmative, the first delay operation is further performed and the LPS operation is subsequently performed.

15. The control method of claim 11, wherein the LPS control procedure further includes:
a second determination step of determining whether the path control switch is turned on; and
a second delay operation of waiting for a second delay time;
wherein when a result of the second determination step is affirmative, the second delay operation is performed and the first determination step is subsequently performed.

16. The control method of claim 11, wherein the LPS operation includes turning off the path control switch or increasing an on-resistance of the path control switch.

17. The control method of claim 11, wherein a current sensing threshold corresponding to the sensing threshold is lower than an absolute value of a current determination threshold corresponding to the determination threshold.

18. The control method of claim 12, wherein when the second current sensing circuit includes the conductive trace segment serially coupled to the current path, the method further comprises:
amplifying a cross-voltage of the conductive trace segment to generate a second amplified signal;
converting the second amplified signal to generate a third digital amplified signal in digital domain, and
performing the LPS control procedure according to the first digital amplified signal and the third digital amplified signal.

19. The control method of claim 18, wherein the conductive trace segment is further coupled to a temperature sensing resistor, and the method further comprises:
providing a bias current;
during a first period, receiving the cross-voltage of the conductive trace segment and performing the LPS control procedure according to the first digital amplified signal and the third digital amplified signal;
during a second period, providing the bias current to the temperature sensing resistor so as to generate a cross-voltage across the temperature sensing resistor; and
during the second period, converting the cross-voltage of the temperature sensing resistor to generate a digital temperature sensing signal in digital domain, and determining, according to the digital temperature sensing signal, whether a temperature of the temperature sensing resistor is higher than an over-temperature protection threshold.
